(19) United States
(12) Patent Application Publication
(10) Pub. No.: US 2008/0311896 A1
(43) Pub. Date: Dec. 18, 2008

(54) METHOD AND SYSTEM FOR A MOBILE MULTI-SERVICE INTERFACE DEVICE

(76) Inventors: Jeyhan Karaoguz, Irvine, CA (US); Arya Behzad, Poway, CA (US); Mark Buer, Gilbert, AZ (US); Alexander G. MacInnis, Ann Arbor, MI (US); Thomas Quigley, Franklin, NC (US); John Walley, Ladera Ranch, CA (US)

Correspondence Address: MCANDREWS HELD & MALLOY, LTD, 500 WEST MADISON STREET, SUITE 3400, CHICAGO, IL, 60661, US

(21) Appl. No.: 12/138,209

(22) Filed: Jun. 12, 2008

Related U.S. Application Data
(60) Provisional application No. 60/943,456, filed on Jun. 12, 2007.

(51) Int. Cl. H04M 3/42

(52) U.S. Cl. 455/416

(57) ABSTRACT

A mobile communication interface (MCI) device may enable utilizing a plurality of communication interfaces to enable connectivity to a plurality of available networks, user interface devices, resources, and/or communication devices; and to support a plurality of users of the MCI device. The communication interfaces may be wired and/or wireless; and may be based on standard network interfaces and/or device-based interfaces. The user devices and/or resources may be local and/or remote, and may comprise service provider devices. Users may interact directly with the MCI device and/or indirectly via communication interfaces. The MCI device may enable concurrent use of the device by a group of supported users; and user specific profiles may be utilized enable determining each user's preferences and operation settings. The user specific profiles may be generated, stored, updated, and/or utilized via the MCI device directly and/or external to the MCI device via its connectivity.

### CROSS-REFERENCE TO RELATED APPLICATIONS/INCORPORATION BY REFERENCE

This patent application makes reference to, claims priority to and claims benefit from U.S. Provisional Application Ser. No. 60/943456 (Attorney Docket No. 18359US01) filed on Jun. 12, 2007.

This application also makes reference to:
U.S. patent application Ser. No. 11/864,184 (Attorney Docket Number 18382US02) filed on Sep. 28, 2007;
U.S. patent application Ser. No. 11/864,269 (Attorney Docket Number 18387US02) filed on Sep. 28, 2007;
U.S. patent application Ser. No. 11/861,220 (Attorney Docket Number 18388US02) filed on Sep. 25, 2007;
U.S. patent application Ser. No. 11/864,562 (Attorney Docket Number 18391US02) filed on Sep. 28, 2007;
U.S. patent application Ser. No. 11/864,407 (Attorney Docket Number 18392US02) filed on Sep.28, 2007;
U.S. patent application Ser. No. 11/861,219 (Attorney Docket Number 18393US02) filed on Sep. 25, 2007;
U.S. patent application Ser. No. 11/968,588 (Attorney Docket Number 18395US02) filed on Jan. 2, 2008;
U.S. patent application Ser. No. 11/865,799 (Attorney Docket Number 18630US02) filed on Oct. 2, 2007;
U.S. patent application Ser. No. 11/864,095 (Attorney Docket Number 18648US02) filed on Sep. 28, 2007; and
U.S. patent application Ser. No. 11/877,088 (Attorney Docket Number 18651US02) filed on Oct. 23, 2007.

Each of the above stated applications is hereby incorporated herein by reference in its entirety.

### FEDERALLY SPONSORED RESEARCH OR DEVELOPMENT

[Not Applicable].

### MICROFICHE/COPYRIGHT REFERENCE

[Not Applicable].

### FIELD OF THE INVENTION

Certain embodiments of the invention relate to mobile communication interface (MCI) devices. More specifically, certain embodiments of the invention relate to a method and system for a mobile multi-service interface device.

### BACKGROUND OF THE INVENTION

The field of mobile and/or wireless communication has seen dramatic growth the last few years. In today's world, most people use wireless devices for various purposes, including business and personal, on a constant and daily basis. Society is truly becoming a mobile and wireless one. Numerous wireless solutions have been introduced, and have made a tremendous impact on everyday life.

For example, the use of Wireless Personal Area Networks (WPAN) has been gaining popularity in a great number of applications because of the flexibility and convenience in connectivity they provide. WPAN systems generally replace cumbersome cabling and/or wiring used to connect peripheral devices and/or mobile terminals by providing short distance wireless links that allow connectivity within very narrow spatial limits (typically, a 10-meter range). WPAN may be based on standardized technologies, for example Bluetooth (BT) technology. While WPAN may be very beneficial for certain applications, other applications may require larger service areas and/or capabilities.

To satisfy such needs, other technologies have been developed to provide greater wireless service. Wireless Local Area Networks (WLAN) systems may operate within a 100-meter range, for example. In contrast to the WPAN systems, WLAN provide connectivity to devices that are located within a slightly larger geographical area, such as the area covered by a building or a campus, for example. WLAN systems are generally based on specific standards, for example IEEE 802.11 standard specifications, and typically operate within a 100-meter range, and are generally utilized to supplement the communication capacity provided by traditional wired Local Area Networks (LANs) installed in the same geographic area as the WLAN system.

Other forms of wireless solutions have evolved from traditional land-based communication technologies. For instance, cellular phones have become just about an absolute necessity in today's world. While cellular technology was merely intended to add an element of mobility to the traditional telephony service, this technology has grown beyond that initial purpose. Many modern cellular technologies, including such technologies as GSM/GPRS/EDGE, UMTS, and CDMA2000, incorporate substantial data capabilities. Most of today's cellular services include such features as text messaging, video streaming, and web browsing, for example.

Placing various wireless technologies in a single communication device is another trend in the wireless world. For instance, some wireless devices such as cell phones may include WLAN and WPAN functionalities. For example, Bluetooth technology may be utilized to connect a laptop computer or a handheld wireless terminal to a peripheral device, such as a keyboard, mouse, headphone, and/or printer, while the laptop computer or the handheld wireless terminal is also connected to a campus-wide WLAN network through an access point (AP) located within the building.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for a mobile multi-service interface device, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram that illustrates exemplary setup for a mobile communication interface (MCI) device, which may be utilized in accordance with an embodiment of the invention.

FIG. 2A is a block diagram that illustrates an exemplary mobile communication interface (MCI) device, which may enable utilizing various wireless and wired interfaces via a plurality of physical (PHY) layers, in accordance with an embodiment of the invention.

FIG. 2B is a block diagram that illustrates an exemplary mobile communication interface (MCI) device that enable user interaction directly, via various user interface modules, and indirectly, via plurality of communication interfaces, in accordance with an embodiment of the invention.

FIG. 3 is a flow chart that illustrates a MCI device enabling use of local and/or remote resources via various user and/or communication interfaces, which may be utilized in accordance with an embodiment of the invention.

### DETAILED DESCRIPTION OF THE INVENTION

Certain embodiments of the invention may be found in a method and system for a mobile multi-service interface device. A mobile communication interface (MCI) device may enable utilizing a plurality of communication interfaces to enable connectivity to a plurality of available networks, user interface devices, resources, and/or communication devices; and to support a plurality of users of the MCI device. The communication interfaces maybe wired and/or wireless. The communication interfaces maybe based on network interfaces, comprising WLAN, PAN, WiMAX, and/or cellular based interface, for example, or maybe device-based interfaces. The user devices and/or resources may be local and/or remote. The resources may comprise service provider devices, which may provide services necessary to perform tasks requested via the MCI device. The MCI device users may interact directly with the MCI device. The MCI device users may also interact indirectly with the MCI device, utilizing various communication interfaces. The MCI device may enable concurrent use of the device by a group of supported users and user profiles may specify various user preferences and operation settings for any of the supported users. The user specific profiles may be generated, stored, updated, and/or utilized via the MCI device directly and/or externally to the MCI device via its connectivity. Each of the supported users may be identified, via the MCI device, using login information, biometric functionality, and/or pre-determined association information, between users and networks, devices, and/or services.

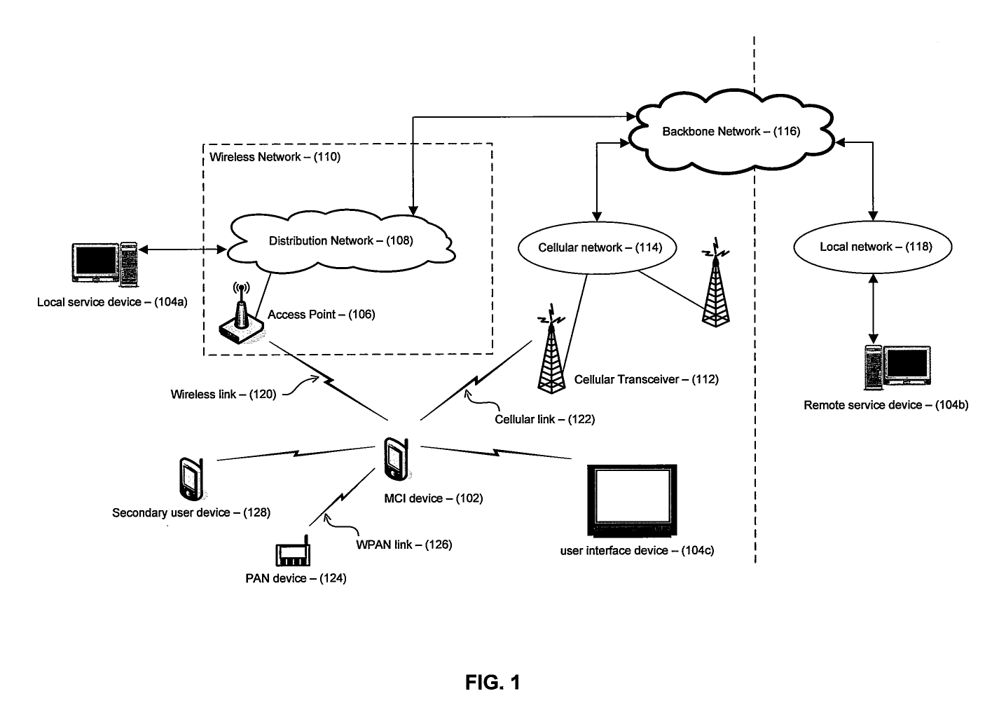

FIG. 1 is a block diagram that illustrates exemplary setup for a mobile communication interface (MCI) device, which may be utilized in accordance with an embodiment of the invention. Referring to FIG. 1, there is shown a mobile communication interface (MCI) device 102, a local service device 104a, a remote service device 104b, a user interface device 104c, an access point 106, a distribution network 108, a wireless network 110, a cellular transceiver 112, a cellular network 114, a backbone network 116, a local network 118, a wireless link 120, a cellular link 122, a Personal Area Networks (PAN) device 124, a Wireless Personal Area Networks (WPAN) link 126, and a secondary user device 128.

The mobile communication interface (MCI) device 102 may comprise suitable logic, circuitry and/or code that may enable portable communications with wireless and/or wired networks. The MCI device 102 may also enable use of local and/or remote resources. A user of the MCI device 102 may utilize the MCI device 102 directly, via supported user interfaces within the MCI device 102 for example, , and/or indirectly via available networks and/or via other devices, such as the PAN device 124 and/or the secondary user device 130, which may interact with the MCI device 102 via communication interfaces. The MCI device 102 may enable concurrent use by a plurality of users. For example, the MCI device 102 may comprise a portable handheld communication device that may be communicatively coupled to plurality of available networks, resources, and/or other communication devices which may exist locally and/or remotely.

The MCI device 102 may comprise functionality that may enable utilizing one or more of available networks, to connect to available devices and/or resources for example. The network connectivity may be achieved directly, wherein the MCI device 102 may be connected via wired connections, including, for example, use of Cat-5 to LAN networks. The network connectivity may also be enabled by the use of one or more wireless communication interfaces that may be supported via the MCI device 102, including, for example, WLAN and/or cellular interfaces. The wireless and/or wired connectivity, via the MCI device 102, may also enable direct interactions with available resources and/or devices based on one or more of these supported wireless and/or wired interfaces. The MCI device 102 may also comprise functionality that may enable use of available resources, which may be located locally and/or remotely, via said network connectivity. For example, the MCI device 102 may be enabled, via available networks and/or direct communication, to utilize the local service device 104a, the remote service device 104b, and/or the user interface device 104c. Consequently, the MCI device 102 may, for example, enable utilizing audio and/or video resources that may enable improved output quality, to enable storage and/or retrieval of data and/or applications via storage resources; and/or to facilitate performing voice, video and/or text message peer-to-peer communication.

The MCI device 102 may comprise a user interface and/or functionality that may enable one or more users to utilize the MCI device 102 as an end user device or an end user terminal device. The MCI device 102 may also comprise functionality that enable supporting a plurality of users, who may access the MCI device 102 directly, or via secondary devices such as the PAN device 124 and/or the secondary user device 130. In addition, to enable the support of plurality of users, the MCI device 102 may comprise functionality to enable generation, storage, modification, and/or utilization of user specific profiles during use of the MCI device 102 by each of the users. The user specific profiles may comprise information pertaining to connectivity, resources use, and/or device operation preferences. Additionally, the MCI device 102 may also comprise, for example, functionality that may enable identifying each of the supported users. The identification may be performed, for example, based on login information, based on compiled association information, between particular user and particular tasks and/or resource, and/or based on determined physical attributes of the user. The physical attributes of the use may be determined utilizing biometric based mechanisms in the WMC device 102. For example, the WMC device 102 may comprise biometric data acquisition subsystem which may enable performing acquisition, validation, and modification of physiological and behavioral biometric data. Biometric data, which may comprise finger prints, retina data, or behavioral patterns, may be unique to a person; and thus it may be utilized to identify a particular use. U.S. patent application Ser. No. 11/861786 filed on Sep. 26, 2007 discloses a method and system for processing information based on detected biometric event data, and is hereby incorporated herein by reference.

The local service device 104a may comprise suitable logic, circuitry and/or code that may be enabled to communicate with the MCI device 102, via one or more of available local networks for example, wireless network 110, to provide a service that may be pertinent to a task requested via the MCI device 102. The invention may not be limited to a specific service device, and may comprise, for example, a general purpose processing device, a specialized processing device, a specialized peripheral device, or any combination of suitable hardware, and/or code, which may be enabled to perform a service requested via the MCI device 102. For example, the local service device 104a may comprise a personal computer (PC), a printer, scanner, and/or fax device, a dedicated memory storage device, and/or a digital video recorder device. Consequently, the local service device 104a may be utilized, for example, as a media service device which may provide multimedia streaming that may be read via the MCI device 102.

The remote service device 104b may be substantially similar to the local service device 104a. However, the remote service device 104b may also comprise functionality to enable remote communication with the MCI device 102, via, for example, the cellular network 110, the backbone network 116, and the local network 118. For example, the remote service device 104b may comprise a home PC comprising fast processing subsystems and/or increased memory space. Such home PC may be better suited to perform processing and/or storage intensive tasks. The MCI device 102 may utilize the remote service device 104b for secure storage of data that may be created and/or maintained in the MCI device 102, as a home gaming service console, and/or as a backup depository for media files.

The user interface device 104c may comprise suitable logic, circuitry and/or code that may be enabled to communicate with the MCI device 102 to perform a function that may be pertinent to a task requested via the MCI device 102, and for which the user interface device 104c may be better suited to perform. For example, the user interface device 104c may comprise a high-definition television (HDTV) set, a dedicated audio system, and/or a digital video player device, which may be optimized to provide improved audio and/or video output quality. The user interface device 104c may be enabled to communicate with the MCI device 102 through any of the available networks via the MCI device 102. Alternatively, the communication between the user interface device 104c and the MCI device 102 may be performed directly based on device-specific interface, which may comprise suitable functionality that enables forming connections between specific devices. For example, the user interface device 104c and the MCI device 102 and the secondary user device 128, may be enabled to utilize a proprietary standard of wireless communication between these devices.

The wireless network 110 may comprise a plurality of the access point 106, the distribution network 108, and suitable logic, circuitry and/or code that may enable implementing a functional block corresponding to a wireless technology. Exemplary wireless technology may comprise for example the WLAN (IEEE 802.11) or the Interoperability for Microwave Access (WiMAX, IEEE 802.16) architecture. The access point 106 may comprise suitable hardware, logic, circuitry, and/or code that may provide access network to the wireless network 110 for wireless capable devices, for example the MCI device 102. The distribution network 108 may comprise suitable hardware, logic, circuitry, and/or code that may be enabled to operate as a backbone network that may be responsible for transport and link functionality for a plurality of access points in the wireless network 110.

The cellular network 114 may comprise plurality of the cellular transceiver 112, and suitable logic, circuitry and/or code that may enable communication via one or more cellular technologies. Exemplary cellular technologies may comprise CDMA, WCDMA, CDMA1000, HSDPA, GSM, GPRS, EDGE, and UMTS. The cellular transceiver 112 may comprise suitable hardware, logic, circuitry, and/or code that may be utilized to enable transmission and/or reception of cellular based communications between the cellular network 114 and cellular capable devices, for example the MCI device 102. For example, the cellular transceiver 112 may correspond to cellular towers and/or base stations within a cellular communication system.

The PAN device 124 may comprise suitable logic, circuitry and/or code that may enable performing some accessory functionality in conjunction with the use of the MCI device 102 based on a PAN protocol. For example, the PAN device 124 may comprise a hands-free headset that may be utilized, in conjunction with the MCI device 102 to facilitated conducting cellular based calls. The MCI device 102 may interact with the PAN device 124 via one or more PAN interfaces, which may be based on wired and/or wireless PAN protocols. For example, the MCI device 102 may communicate with the PAN device 124 via the WPAN link 126. The WPAN link 126 may be based on a standardized technology for inter-device short range communication. For example, the WPAN link 126 may correspond to Bluetooth, ZigBee, and/or Ultra-Wideband (UWB) connections between the PAN device 124 and the MCI device 102.

The backbone network 116 may comprise suitable hardware, logic, circuitry, and/or code that may be operable to provide overall system connectivity among local and/or remote sub-networks. The backbone network 116 may be enabled to interact with, and connect different wired and/or wireless technologies. For example, the backbone network may comprise a standard telephony network (POTS) that may enable data connectivity between different interface nodes linking wired and/or wireless networks comprising WLAN networks, WiMAX networks, cellular networks, and/or LAN networks.

The local network 118 may comprise suitable logic, circuitry and/or code that may enable local connectivity. This local connectivity may comprise use of Local Area Network (LAN) technologies that enable data services, including but not limited to, IEEE 802.3 Ethernet. Other technologies may comprise WiMAX. The local network 118 may be accessed, for example, by the MCI device 102, via wireless network 110 and/or the cellular network 114, and the backbone network 116.

The secondary user device 128 may comprise suitable logic, circuitry and/or code that may enable communications with the MCI device 102 to enable utilizing any of the available networks and/or resources via the MCI device 102. The communications between the secondary user device 128 and the MCI device 102 may be performed via a wireless link, which may be based on a wireless protocol comprising, for example, WLAN based interfaces. Alternatively, the communication between the secondary user device 128 and the MCI device 102 may be based on device-specific interface, which may be operable to provide communication between specific devices. For example, a manufacturer of a type of wireless devices, which may comprise the MCI device 102 and the secondary user device 128, may utilize a proprietary standard of wireless communication between these devices. The secondary user device 128 may be utilized to allow access by a user to the MCI device 102. The secondary user device 128 may also be accessed by the MCI device 102 to enable performing a task requested by a user of the MCI device 102.

In operation, the MCI device 102 may be utilized to enable connectivity via a plurality of available networks and/or communication interfaces. For example, the MCI device 102 may utilize the wireless link 120 to access the wireless network 110 via the access point 106. The MCI device 102 may also utilize the cellular link 122 to access the cellular network 114 via the cellular transceiver 112. The MCI device 102 may communicate with the local service device 104a via the wireless network 110 through the access point 106 and the distribution network 108. The distribution network 108 and/or the cellular network 114 may also enable forwarding messages and/or data sent from, and to the MCI device 102. The backbone network 116 may enable connectivity between local networks, for example wireless network 110, and cellular network 114, and to remote networks, comprising, for example, the local network 118. The remote service device 104b may receive communication from the MCI device 102 by interacting with the backbone network 116 via the local network 118. Protocol-based operations may be performed to facilitate the transmission of information through all the different components. This may comprise use of exemplary protocols such as TCP, IP, UPD, and/or SS7. The MCI device 102 may also be enabled to communicate directly with other devices and/or resources. For example, the MCI device 102 may communicate directly with the PAN device 124 via the WPAN link 126. The MCI device 102 may also communicate with the secondary user device 128 and/or the user interface device 104c, and such communication may be based on existing wireless and/or wired interfaces, and/or the communication may be based on device-specific interfaces that may be limited to class of devices comprising the MCI device 102, the secondary user device 128 and/or the user interface device 104c.

The MCI device 102 may be utilized to support a plurality of users. A user of the MCI device 102 may request tasks that may be performed utilizing the connectivity of MCI device 102 to available networks, devices, and/or resources. For example, the MCI device 102 may be enabled to communicate with the local service device 104a and/or the remote service device 104b to facilitate accessing of services provided by the local service device 104a and/or the remote service device 104b. Consequently, the MCI device 102 may be enabled to access, for example, media, storage, processing, and/or gaming services based on one or more tasks requested by a user of the MCI device 102. The MCI device 102 may also be enabled to utilize communication and/or user interface devices available via the communication interfaces within the MCI device 102. For example, when requested by a user, the MCI device 102 may communicate multimedia files received from the local service device 104a and/or the remote service device 104b to the user interface device 104c to enable improved output quality of audio and/or video contents of the multimedia files. The MCI device 102 may be enabled to generate, store, and/or update user specific profiles that maybe utilized in identifying and/or authenticating particular users of the device, and/or in facilitating use of the MCI device 102 by particular users to perform requested tasks. The user specific profile may also be generated, stored, and/or updated remotely, in the remote service device 104b for example, based on communications via the MCI device 102, to ensure security and/or efficiency for example. The user specific profile may comprise, for example, network connectivity, service access, secure access information, user preference information, and/or network and service access information and/or preferences that are unique to particular users. For example, a user specific profile may specify particular devices, for example, the remote service device 104b, which may be accessed to perform certain type of operations. User specific profiles may also specify connectivity related information comprising, for example, types of networks to be connectively coupled to, the wireless network 110 for example, and/or other performance related criteria such as cost, availability, bandwidth level, QoS capabilities, security, and reliability. The MCI device 102 may also enable a set of the plurality of supported users to share user specific profiles, wherein such set of users may be treated as a specific group.

The MCI device 102 may be enabled to identify particular user in variety of manners. For example, the MCI device 102 may identify a particular user by login information, which may be determined based on user specific profiles; physical attributes of the person, which may be derived from biometric functionality that may integrated within the MCI device 102 or utilized externally to it; and/or based on predetermined associations between particular user and peripheral devices, resources, and/or communication interfaces.

The MCI device 102 may be enabled to support concurrent use by multiple users. For example, a first user may access the MCI device 102, via the PAN device 124 and the WPAN link 126, to initiate and/or terminate a voice call via the cellular network 114. A second distinct user may concurrently access the MCI device 102, directly, access media service provided via the local service device 104a, through the wireless network 110. In supporting concurring use, the MCI device 102 may utilize user identification functionality and/or user specific profiles.

In an embodiment of the invention, the MCI device 102 may be utilized as a hub and/or router between available networks, user interface devices, resources, and/or communication devices. For example, the MCI device 102 may, for example, be utilized to enable a first user to utilize the MCI device 102 to access a music streaming service, via the local service 104a for example, and to retrieve and audio stream information, which may be played via the PAN device 124. A second user may concurrently utilize the MCI device 102 to access a video streaming service, via the remote service 104b, and to retrieve a video stream file. The MCI device 102 may then discover, while continuing to support the first user, the presence of the user interface device 104c, which may be determined to provide improved video display quality, and may route the retrieved video stream to the user interface device 104c when such routing is permitted based on the second user's specific profile.

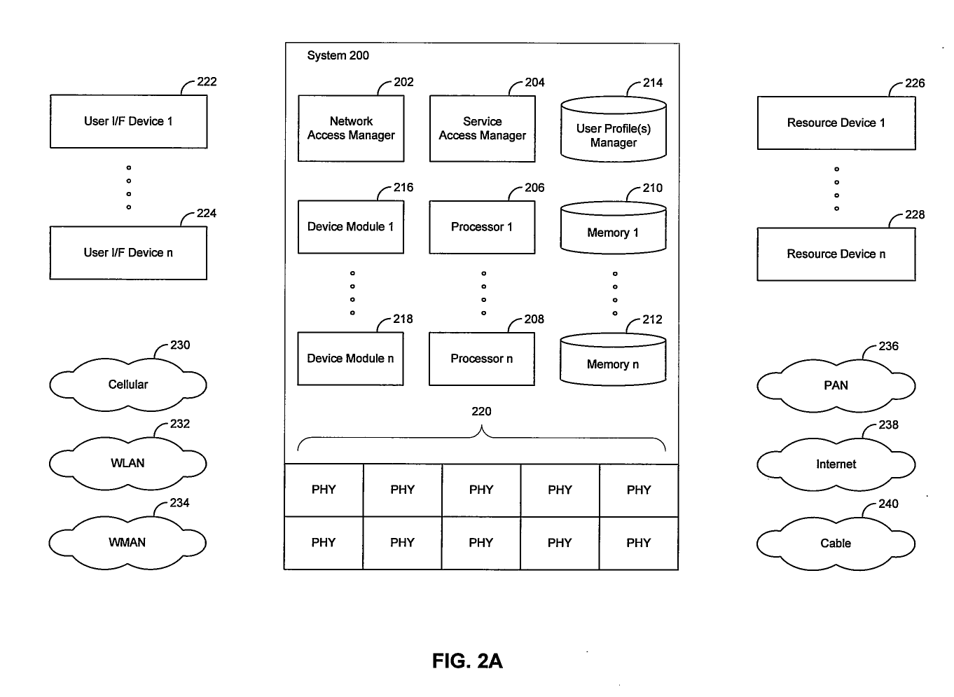

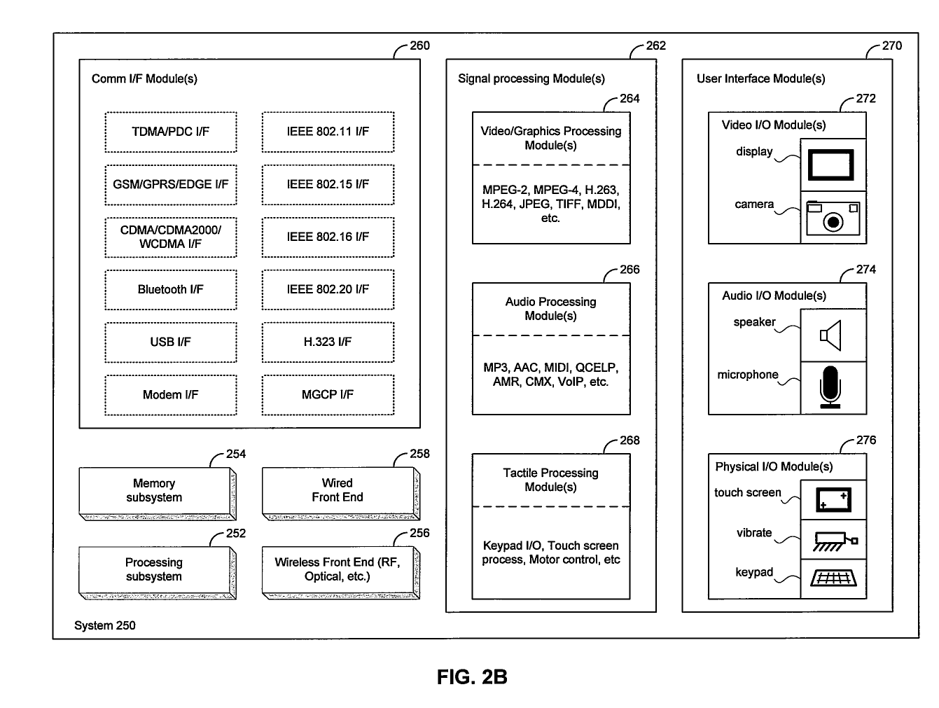

FIG. 2A is a block diagram that illustrates an exemplary mobile communication interface (MCI) device, which may enable utilizing various wireless and wired interfaces via a plurality of physical (PHY) layers, in accordance with an embodiment of the invention. Referring to FIG. 2A, there is shown a system 200, a network access manager 202, a service access manager 204, a plurality of processors 206, . . . , 208, a plurality of memory 210, . . . , 212, a user profiles manager 214, and a plurality of device modules 216, . . . , 218. FIG. 2A also shows a plurality of PHY layers 220, a plurality of user I/F devices 222, . . . , 224, a plurality of resource devices 226, . . . , 228, a cellular network 230, a wireless local area network (WLAN) 232, a Wireless Metropolitan Area Networks (WMAN) 234, PAN network 236, an internet network 238, and a cable network 240.

The system 200 may comprise the network access manager 202, the service access manager 204, the plurality of processors 206, . . . , 208, the plurality of memory 210, . . . , 212, the user profiles manager 214, the plurality of device modules 216, . . . , 218, the plurality of PHY layers 220, and may also comprise additional suitable logic, circuitry, and/or code that may enable utilizing various wireless and wired interfaces via a plurality of PHY layers. For example, the system 200 may be integrated within a mobile communication interface (MCI) device, for example the MCI device 102, to enable the MCI device to interact with various networks, resources, and/or communication devices, substantially as described in FIG. 1.

Each of the plurality of processors 206, . . . , 208, may comprise suitable logic, circuitry and/or code that may enable performing processing operations. The invention may not be limited to a specific processor, but may comprise for example, a general purpose processor, a specialized processor or any combination of suitable hardware, firmware, software and/or code, which may be enabled to provide particular processing operations. For example, one of the plurality of processors 206, . . . , 208, may be utilized to provide CPU like operation within the system 200, while one or more other processors may be utilized to provide specialized and/or generic operations comprising, for example, digital signal processing (DSP), network processing, audio processing, and video processing. Each of the plurality of memory 210, . . . , 212 may comprise suitable logic, circuitry and/or code that may enable permanent and/or non-permanent storage and retrieval of data and/or code, which may be utilized, for example, by one or more the plurality of processors 206, . . . , 208, during processing operations.

The network access manager 202 may comprise suitable logic, circuitry, and/or code that may enable performing management and/or control operations that may facilitate access to available networks. For example, the network access manager 202 may be utilized within the system 200 to enable access to one or more of the cellular network 230, the WLAN network 232, the WMAN network 234, the PAN network 236, the internet network 238, and/or the cable network 240. Each of the plurality of PHY layers 220 may correspond to the physical layer within the Open System Interface (OSI) model, which may enable transmitting raw bits via communication links based on a wired or wireless interface. For example, one of the plurality of PHY layers 220 may correspond to the physical layer within the Bluetooth stack, which may comprise functionality that enable transmission and/or reception of raw bits via Bluetooth based communication links.

The service access manager 204 may comprise suitable logic, circuitry, and/or code that may enable performing management and/or control operations that may facilitate access to available services. For example, in instances where the system 200 may be integrated within the MCI device 102, the service access manager 204 may enable performing of management operations that may enable access to services provided, for example, via the local service device 104a and/or the remote service device 104b. These services may be utilized to perform tasks requested via the MCI device 102. The user profiles manager 214 may comprise suitable logic, circuitry, and/or code that may enable performing of management and/or control operations pertaining to the user profiles corresponding to supported users of a device that may comprise the system 200. For example, where the system 200 may be integrated within the MCI device 102, the user profiles manager 214 may enable generation, storage, updating, and/or use of user profiles, substantially as described with respect to FIG. 1. Each of the plurality of device modules 216, . . . , 218, may comprise suitable logic, circuitry, and/or code that may enable, via system 200, communication with, management of, and/or control of a particular external device, for example one of the plurality of user I/F devices 222, . . . , 224, and/or the plurality of resource devices 226, . . . , 228.

Each of the plurality of user I/F devices 222, . . . , 224, may comprise suitable logic, circuitry and/or code that may be enabled to performing, external to device comprising the system 200, one or more user interface like operations, comprising, for example, audio and/or video display operations. For example, the plurality of user I/F devices 222, . . . , 224, may comprise user interface device 104c, substantially as described in FIG. 1. Each of the plurality of resource devices 226, . . . , 228, may comprise suitable logic, circuitry and/or code that may be enabled to provide, external to device comprising the system 200, particular services and/or functionality. For example, the plurality of resource devices 226, . . . , 228, may comprise the local service device 104b, substantially as described with respect to FIG. 1.

The cellular network 230 may comprise suitable logic, circuitry and/or code that may enable implementing a functional block corresponding to a cellular technology, comprising, for example, but not limited to, CDMA, WCDMA, CDMA1000, HSDPA, GSM, GPRS, EDGE, and/or UMTS. The WLAN network 232 may comprise suitable logic, circuitry and/or code that may enable implementing a functional block corresponding to a WLAN protocol, including, for example, IEEE 802.11. The WMAN network 234 may comprise suitable logic, circuitry and/or code that may enable implementing a functional block corresponding to a WMAN protocol, comprising, for example, IEEE 802.16. The PAN network 236 may comprise suitable logic, circuitry and/or code that may enable implementing a functional block corresponding to a PAN interface. The PAN network 236 may comprise wired based connectivity, via buses such as Universal Serial Bus (USB), for example. Additionally, wireless personal area network (WPAN) may be utilized, comprising, for example, WPAN technologies such as Bluetooth (IEEE 802.15), UWB, and/or ZigBee. The Internet network 238 may comprise suitable logic, circuitry and/or code that may enable implementing a functional block corresponding to an internet protocol, including, for example, Internet Protocol (IP). The cable network 240 may comprise suitable functionality and/or distribution systems that may enable forwarding of cable based communication from the cable head-ends to TV display devices.

In operations, the system 200 may be integrated within a device, for example the MCI device 102, to enable utilizing a plurality of wireless and/or wired interfaces via a plurality of physical layers, to facilitate interacts with various networks, resources, and/or communication devices. The plurality of processors 206, . . . , 208, and/or plurality of memory 210, . . . , 212, may be utilized to enable overall control and management, and/or processing and/or control during particular operations within the system 200, for example, during DSP, audio, and/or video processing.

In instances where the system 200 may be integrated within the MCI device 102, it may enable performing connectivity related operations to facilitate performing tasks requested via the MCI device 102. For example, network connectivity may be performed via the network access manager 202, which may enable managing access to one or more of the cellular network 230, the WLAN network 232, the WMAN network 234, the PAN network 236, the internet network 238, and/or the cable network 240. During network accessibility operations, the system 200 may utilize appropriate PHY functionality, within the plurality of PHY layers 220, to enable transmission and/or reception of communication between the system 200 and the corresponding network and/or device. For example, to facilitate connectivity with the WLAN network 232, the network access manager 202 may be enabled to utilize a WLAN PHY within the system 200 to perform WLAN based communications. The service access manager 204 may enable managing access to particular services, which may be provided via particular external devices, example the plurality of resource devices 226, . . . , 228. One or more of the plurality of device modules 216, . . . , 218 may be utilized to enable communicating with, managing of, and/or controlling of devices. During service access operations, the service access manager 204 may utilize network connectivity, via the network access manager 202, to enable access to the desired devices. Alternatively, the service access manager 204 may be enabled to utilize appropriate PHY functionality in the system 200, within the plurality of PHY layers 220, to enable transmission and/or reception of information between the system 200 and the corresponding device.

The system 200 may also enable the MCI device 102 to utilize one or more of the plurality of user I/F devices 222, . . . , 224, which may be utilized to perform dedicated user interface operations that may not be available, or optimal, directly via the MCI device 102. For example, one or more of the plurality of device modules 216, . . . , 218 maybe utilized to enable communicating with, managing of, and/or controlling of one or more of the plurality of user I/F devices 222, . . . , 224. Additionally, the system 200 may use one or more of the plurality of PHY layers 220 to communicate directly with the devices, and/or indirectly via available networks. During various operations of the system 200, the user profiles manager 214 may enable performing user specific profiles related operations, substantially as described in FIG. 1.

FIG. 2B is a block diagram that illustrates an exemplary mobile communication interface (MCI) device that may enable user interaction directly, via various user interface modules, and indirectly, via plurality of communication interfaces, in accordance with an embodiment of the invention. Referring to FIG. 2B, there is shown a system 250, a processing subsystem 252, a memory subsystem 254, a wireless front-end 256, a wired front-end 258, communication interface (I/F) modules 260, signal processing modules 262, video processing modules 264, audio processing modules 266, tactile processing modules 268, user interface modules 270, video input/output (I/O) modules 272, audio I/O modules 274, and physical I/O modules 276.

The system 250 may comprise the processing subsystem 252, the memory subsystem 254, the wireless front-end 256, the wired front-end 258, the communication interface (I/F) modules 260, the signal processing modules 262, the video processing modules 264, the audio processing modules 266, the tactile processing modules 268, the user interface modules 270, the video I/O modules 272, the audio I/O modules 274, the physical I/O modules 276, and may also comprise additional suitable logic, circuitry, and/or code that may enable direct and/or indirect interaction between the system 250 and external entities. For example, the system 250 may be integrated within a mobile communication interface (MCI) device, for example the MCI device 102, to enable user interaction directly, via various user interface modules, and indirectly, via a plurality of communication interfaces, substantially as described with respect to FIG. 1.

The processing subsystem 252 may comprise suitable logic, circuitry and/or code that may enable performing processing operations, comprising general control and/or processing functionality, and/or processing pertinent to particular tasks and/or operations. For example, the processing subsystem 252 may be comprised substantially similar to the plurality of processors 206, . . . , 208, as described in FIG. 2A. The memory subsystem 254 may comprise suitable logic, circuitry and/or code that may enable storage and/or retrieval of data and/or code in the system 250. For example, the memory subsystem 254 may be substantially similar to the plurality of memory 210, . . . , 212, as described in FIG. 2B.

The wireless front-end 256 may comprise suitable logic, circuitry and/or code that may enable transmission and/or reception of communication via one or more wireless based interface. For example, the wireless front-end 256 may comprise antenna systems that may enable transmission and/or reception of communication via WLAN, Bluetooth, WiMAX, and/or cellular based interfaces. The wired front-end 258 may comprise suitable logic, circuitry and/or code that may enable transmission and/or reception of communication via one or more wired based interface. For example, the wired front-end 258 may enable communications via USB terminals, cable modem connectivity, external memory devices interfaces, and/or FireWire interface.

The communication interface (I/F) modules 260 may comprise suitable logic, circuitry and/or code that enable, via the system 250, utilization, control, and/or management of communication via plurality of communication interfaces, for example via the wireless front-end 256 and/or the wired front-end 258. For example, the communication I/F modules 260 may comprise modules to enable communication via various wireless and/or wired communication interface, comprising, Bluetooth interface, other WPAN (IEEE 802.15) interface, WLAN (IEEE 802.11) interface, WiMAX (IEEE 802.16) interface, Mobile Broadband Wireless Access (MBWA, IEEE 802.20) interface, Time Division Multiple Access/Personal Digital Cellular (TDMA/PDC) interface, GSM/GPRS/EDGE interfaces, CDMA/CDMA200/WCDMA interfaces, H.323 interface, USB interface, Modem interface, and/or Media Gateway Control Protocol (MGCP) based interface.

The signal processing modules 262 may comprise the video processing modules 264, the audio processing modules 266, the tactile processing modules 268, and may also suitable logic, circuitry and/or code that enable performing, controlling, and/or managing various signal processing operations, for example via the processing subsystem 252, the memory subsystem 254, and/or the user interface modules 270. The video processing modules 264 may comprise suitable logic, circuitry and/or code that enable performing, controlling, and/or managing video based signal processing. For example, the video processing modules 264 may enable performing processing of video signals generated and/or received via the video I/O modules 272. The video signals may be based on one or more encoding schemes, comprising, for example, Moving Picture Experts Group 2 (MPEG-2), MPEG-4, H.263, H.264, Joint Photographic Experts Group (JPEG), Tagged Image File Format (TIFF), and/or MDDI. The audio processing modules 266 may comprise suitable logic, circuitry and/or code that enable performing, controlling, and/or managing audio based signal processing. For example, the audio processing modules 266 may enable performing processing of video signals generated and/or received via the audio I/O modules 274, wherein the audio signals may be based on one or more encoding schemes, including, for example, MPEG-3 Audio Layer 3 (MP3), Advanced Audio Coding (AAC), Musical Instrument Digital Interface (MIDI), Qualcomm Code Excited Linear Prediction (QCELP), Adaptive Multi-Rate (AMR), and/or Voice-over-IP (VoIP). The tactile processing modules 268 may comprise suitable logic, circuitry and/or code that enable performing, controlling, and/or managing physical based signal processing. For example, the tactile processing modules 266 may enable performing processing of signals generated and/or received via the physical 1/O modules 276.

The user interface modules 270 may comprise the video I/O modules 272, the audio I/O modules 274, the physical I/O modules 276, and may also comprise suitable logic, circuitry and/or code that enable utilization of various user interfaces that may be available via the system 250. For example, the system 250 may be integrated within a device, for example the MCI device 102, to enable supporting user interfaces in the device to enable direct interactions with the device by users of the device. The video I/O modules 272 may comprise suitable logic, circuitry and/or code that may enable utilization of video based input/output (I/O) interfaces. For example, the video I/O modules 272 may enable utilization of display and/or digital camera components in the system 250, which may enable capturing and/or displaying still pictures and/or video streams via the system 250. The audio I/O modules 274 may comprise suitable logic, circuitry and/or code that enable utilization of audio based input/output (I/O) interfaces. For example, the audio I/O modules 274 may enable utilization of speaker and/or microphone components in the system 250, which may enable capturing and/or playing audio streams via the system 250. The physical I/O modules 276 comprise suitable logic, circuitry and/or code that enable utilization of physical based input/output (I/O) interfaces. For example, the physical I/O modules 276 may enable utilization of touch screen, vibrate and/or keypad components in the system 250, which may enable receiving and/or generating physical based interactions with a user, via the system 250.

In operation, the system 250 may be integrated within a device, for example the MCI device 102, to enable user interactions directly, via various user interface modules, and/or indirectly, via plurality of communication interfaces. For example, a user may interact directly with the system 250, via the video I/O modules 272, the audio I/O modules 274, and/or the physical I/O modules 276. The video processing modules 264, the audio processing modules 266, and the tactile processing modules 268 may enable performing necessary signal processing in conjunction with such direct interactions. A user may also be enabled to interact indirectly via the system 250. For example, communications between users and the system 250 may be transmitted and/or received via the wireless front-end 256 and/or the wired front-end 258, based on one or more of the various interfaces supported via the communication I/F modules 260.

In an embodiment of the invention, the processing subsystem 252, the memory subsystem 254, the communication I/F modules 260, and/or the signal processing modules 262, for example, may enable performing additional operations. The system 250 may enable, for example, buffering and/or storage of data communicated by one or more users, via the memory subsystem 254, for example. The stored data may subsequently be communicated, for example, where proper external resources are discovered and become coupled with a device comprising the system 250. The system 250 may also enable providing transcoding functionality. For example, a device comprising system 250 may be utilized as an interface between an Internet media streaming service and a Bluetooth enabled device. The system 250 may be operable to transcode information between Internet and Bluetooth protocols. The system 250 may also enable performing encoding and/or decoding operations. For example, where a device comprising the system 250 may be coupled into a plurality of resources utilizing differing encoding schemes. Finally, the system 250 may enable performing of a variety of filtering operations. For example, where various communication interfaces and/or media and/or data formats may require particular types of filtering, the system 250 may enable performing such filtering operations.

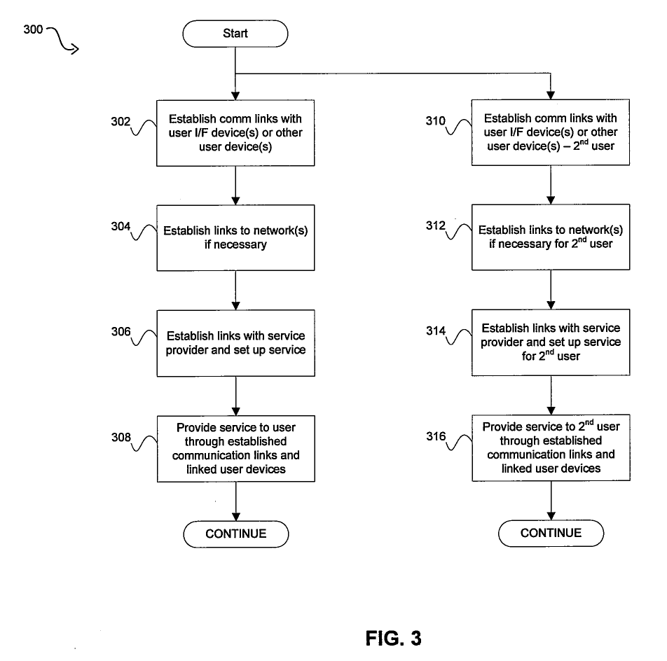

FIG. 3 is a flow chart that illustrates a MCI device enabling use of local and/or remote resources via various user and/or communication interfaces, which may be utilized in accordance with an embodiment of the invention. Referring to FIG. 3, there is shown a flow chart 300 comprising a plurality of exemplary steps, which may enable concurrent use of an MCI device to perform network and/or service connectivity via the device.

In step 302, communication links with user I/F devices and/or other user device may be established. For example, in instances where MCI device 102 may comprise the system 200 and/or the system 250, the MCI device 102 may be enable to establish connectivity with the user interface device 104c, the WPAN device 124, and/or the secondary user device 128. The user may also be enabled to interact directly with the MCI device 102, substantially as described with respect to FIG. 1, and FIG. 2B. In step 304, network connectivity, if necessary, may be established. For example, in instances where MCI device 102 may comprise the system 200 and/or the system 250, communication interfaces based on available wired and/or wireless networks may be utilized to establish network connectivity. In step 306, connectivity with service provider, if necessary, may be established, and required services may be setup. For example, the MCI device 102 may be enabled to establish connectivity with the local service device 104a and/or the remote service device 104b, which may be enabled to provide services that may be necessary to perform tasks requested via the MCI device 102, substantially as described with respect to FIG. 1. In step 308, services may be provided to user through established communication links and/or linked user devices. In step 310, communication links with user I/F devices and/or other user device may be established, substantially as described in step 302, to enable supporting a second user, possibly concurrent to supporting the first user. In step 312, network connectivity, if necessary, may be established, substantially as described in step 304, to enable supporting a second user, which may be concurrent to supporting the first user. In step 306, connectivity with the service provider, if necessary, may be established, and required services may be setup, substantially as described in step 306, to enable supporting a second user, which may be concurrent to supporting the first user. In step 308, services may be provided to user through established communication links and/or linked user devices, to enable supporting a second user, possibly concurrent to supporting the first user.

Various embodiments of the invention may comprise a method and system for mobile multi-service interface device. The mobile communication interface (MCI) device 102 may enable utilizing a plurality of communication interfaces, via the system 200 and/or the system 250 for example, to enable connectivity to a plurality of available networks, user interface devices, resources, and/or communication devices; and to support a plurality of users of the MCI device 102. The communication interfaces maybe wired and/or wireless. The communication interfaces maybe based on network interfaces, comprising WLAN, PAN, WIMAX, and/or cellular based interface for example; or maybe device-based interfaces. The user devices and/or resources may be local and/or remote. The resources may comprise service provider devices, which may provide services necessary to performing tasks requested via the MCI device 102. The MCI device 102 users may interact directly with the MCI device, via the user interface modules 270 in the system 250 for example. The MCI device 102 users may also interact indirectly with the MCI device 102 via communication interfaces, via the communication I/F modules 260 and the wireless front-end 256, the wired front-end 258 in the in the system 250 for example; and/or utilizing the plurality of PHY layers 220 in the system 200. The MCI device 102 may enable concurrent use of the device by a group of supported users; and user specific profiles may enable determining user preferences and operation settings for any of the supported users. The user specific profiles may be generated, stored, updated, and/or utilized via the MCI device, for example using the user profiles manager 214 in the system 200, directly and/or external to the MCI device 102 via its connectivity. Each of the supported users may be identified, via the MCI device 102, using login information, biometric functionality, and/or pre-determined association information, between users and networks, devices, and/or services.

Another embodiment of the invention may provide a machine and/or computer readable storage and/or medium, having stored thereon, a machine code and/or a computer program having at least one code section executable by a machine and/or a computer, thereby causing the machine and/or computer to perform the steps as described herein for a mobile multi-service interface device.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for communication, the method comprising:
in a mobile device comprising a plurality of communication interfaces operable to bridge networks, devices, and/or resources to concurrently support a plurality of users,
receiving a plurality of task requests from said plurality of users; and
allocating and/or routing at least a portion of said plurality of task requests to one or more of said networks, devices and/or resources that are available based on user specific profile information associated with said plurality of users.

2. The method according to claim 1, comprising receiving and/or generating information via a user interface within said mobile device that enables said plurality of users to interact with said mobile device.

3. The method according to claim 1, comprising receiving and/or generating information via one or more of said plurality of communication interfaces within said mobile device to enable said plurality of users to interact with said mobile device.

4. The method according to claim 1, comprising generating, storing, and/or updating said user specific profile via said mobile device said mobile communication interface device by any of said plurality of users.

5. The method according to claim 1, wherein each of said user specific profile comprises network connectivity preferences, secure user access, device operation preferences, and/or service related preferences information.

6. The method according to claim 1, comprising identifying each of said plurality of users of said mobile device upon said receiving of said plurality of task requests.

7. The method according to claim 6, comprising performing said identification of each of said plurality of users based on inputted login information, biometric functionality, and/or pre-determined user association information, based on particular services, devices, and/or resources.

8. The method according to claim 1, wherein said networks, devices and/or resources that are available comprise local and/or remote resources.

9. The method according to claim 8, wherein one or more of said local and/or remote resources comprise service provider devices.

10. The method according to claim 8, wherein one or more of said local and/or remote resources comprise user interface devices.

11. The method according to claim 1, wherein said plurality of communication interfaces comprise one or more of a device-specific interfaces that are supported via said mobile communication interface device.

12. The method according to claim 1, wherein said plurality of communication interfaces comprise one or more wireless interfaces.

13. The method according to claim 1, wherein said available networks comprise a local internet network, a cable network, a wireless personal area network (PAN), a wireless local area network (WLAN), a Worldwide Interoperability for Microwave Access (WiMAX) network, and/or a cellular network.

14. The method according to claim 1, comprising communicating with said networks, devices and/or resources that are available via said plurality of communication interfaces, based on dynamic determination performed when said plurality of task requests are received from any of said plurality of users.

15. The method according to claim 14, wherein said dynamic determination is based on cost, availability, bandwidth level, QoS capabilities, security, and/or reliability.

16. The method according to claim 1, comprising performing encoding, decoding, transcoding, formatting and/or filtering to enable said concurrent support of said plurality of users.

17. A system for communication, the system comprising:
one or more processors in a mobile communication interface device that enable supporting of a plurality of communication interfaces operable to bridge networks, devices, and/or resources to concurrently support a plurality of users;
said one or more processors enable receiving of a plurality of task requests from said plurality of users; and
said one or more processors enable allocation and/or routing of at least a portion of said plurality of task requests to one or more of said networks, devices and/or resources that are available based on user specific profile information associated with said plurality of users.

18. The system according to claim 17, wherein said one or more processors enable utilization of a user interface, within said mobile communication interface device, to enable one or more of said plurality of users to interact directly with said mobile communication interface device.

18. The system according to claim 17, wherein said one or more processors enable reception and/or generation of information via a user interface within said mobile device that enables said plurality of users to interact with said mobile device.

19. The system according to claim 17, wherein said one or more processors enable reception and/or generation of information via one or more of said plurality of communication interfaces within said mobile device to enable said plurality of users to interact with said mobile device.

20. The system according to claim 17, wherein said one or more processors enable generation of, storing of, and/or updating of said user specific profile via said mobile device said mobile communication interface device by any of said plurality of users.

21. The system according to claim 17, wherein each of said user specific profile comprises network connectivity preferences, secure user access, device operation preferences, and/or service related preferences information.

22. The system according to claim 17, wherein said one or more processors enable identification of each of said plurality of users of said mobile device upon said receiving of said plurality of task requests.

23. The system according to claim 22, wherein said one or more processors enable performing of said identification of each of said plurality of users based on inputted login information, biometric functionality, and/or pre-determined user association information, based on particular services, devices, and/or resources.

24. The system according to claim 17, wherein said networks, devices and/or resources that are available comprise local and/or remote resources.

25. The system according to claim 24, wherein one or more of said local and/or remote resources comprise service provider devices.

26. The system according to claim 24, wherein one or more of said local and/or remote resources comprise user interface devices.

27. The system according to claim 17, wherein said plurality of communication interfaces comprise one or more of a device-specific interfaces that are supported via said mobile communication interface device.

28. The system according to claim 17, wherein said plurality of communication interfaces comprise one or more wireless interfaces.

29. The system according to claim 17, wherein said available networks comprise a local internet network, a cable network, a wireless personal area network (PAN), a wireless local area network (WLAN), a Worldwide Interoperability for Microwave Access (WiMAX) network, and/or a cellular network.

30. The system according to claim 17, wherein said one or more processors enable communication with said networks, devices and/or resources that are available via said plurality of communication interfaces, based on dynamic determination performed when said plurality of task requests are received from any of said plurality of users.

31. The system according to claim 30, wherein said dynamic determination is based on cost, availability, bandwidth level, QoS capabilities, security, and/or reliability.

32. The system according to claim 17, wherein said one or more processors enable encoding, decoding, transcoding, formatting and/or filtering to enable said concurrent support of said plurality of users.
